(19) United States
(12) Patent Application Publication
(10) Pub. No.: US 2025/0155392 A1
(43) Pub. Date: May 15, 2025

(54) Gas Detection System

(71) Applicant: General Biophysics LLC, Framingham, MA (US)

(72) Inventors: Ilya Ilin, Wayland, MA (US); George Hagopian, Boston, MA (US); Ivan Lukashev, Ashland, MA (US); Paul Yudin, Hollis, NH (US)

(21) Appl. No.: 18/947,803

(22) Filed: Nov. 14, 2024

Related U.S. Application Data
(60) Provisional application No. 63/599,023, filed on Nov. 15, 2023.

(51) Int. Cl. G01N 25/18; G01N 1/24

(52) U.S. Cl. CPC G01N 25/18; G01N 1/24

(57) ABSTRACT

The present disclosure relates to a gas detection system and associated method including a sensing system and a controller in digital communication wherein a gaseous mixture is flowed through the gas detection system to measure the thermal conductivity level of the gaseous mixture by a thermal conductivity sensor. The controller generates a set of calibration values that are utilized to compare to the measured thermal conductivity level to calculate a gas concentration of the gaseous mixture to display to a user on the controller.

### CROSS REFERENCE TO RELATED APPLICATION

This application claims the benefit of and takes priority from U.S. Provisional Patent Application Ser. No. 63/599,023 filed on Nov. 15, 2023, the contents of which are herein incorporated by reference.

### BACKGROUND OF THE INVENTION

### Field of the Invention

The present disclosure relates generally to gas concentration detection systems, devices, and methods. More particularly, exemplary embodiments of the disclosure include a gas detection system and corresponding method of detection utilizing a thermal conductivity sensor and controller to identify specific concentrations of a gaseous mixture.

### Description of the Related Art

The determination of gas concentrations is vastly beneficial in many applications. Specifically, determining and identifying gaseous concentrations is applicable in medical and pharmaceuticals systems/processes, modified atmospheric storage and manufacturing, electronics (display manufacturing, laser generation), gas blending and mixing, aerospace (fuel for electric propulsion systems), automotive (headlamp manufacturing), and welding. Censoring and monitoring systems are installed within said workplaces in order to provoke safety when working with harmful gases. Censoring and monitoring systems are installed within said workplaces in order to prevent harm when working with toxic gases.

Traditional gas censoring and monitoring systems utilize special techniques and stagnant proportions of gases in an environment to obtain an analysis and calculation of such gases via thermal conductivity. However, these methods require non-shifting amounts of gases in order to be read accurately.

Further, the utilization of conventional gas detection systems present issues in precise accuracy and efficiency. For instance, conventional gas detection systems house long tubing in order to transport gas from a gaseous environment to a testing site. During this transportation, long tubing creates excessive aerodynamic resistance and make it longer for gas to reach the measuring chamber. As a result, concentration measurements are less accurate. Further, conventional gas detection systems and methods do not analyze, calculate, nor detect gaseous concentrations instantaneously.

### SUMMARY OF THE INVENTION

The instant system and corresponding method, as illustrated herein, is clearly not anticipated, rendered obvious, or even present in any of the prior art mechanisms, either alone or in any combination thereof. Thus, the several embodiments of the instant system and method are illustrated herein.

A primary object of the present disclosure is to provide a system preferably for detecting a gas concentration level and to provide a set of thermal conductivity levels of gaseous mixtures to determine gaseous concentrations of individual gases in a gaseous mixture.

Another object of the present disclosure is to provide a method for the utilization of the gas detection system to provide accurate concentration readings of gases in a gaseous mixture in a quick and timely manner.

In one aspect of the preferred embodiment, a gas detection system is disclosed that includes a sensing system coupled with a controller, wherein the sensing system may include a housing with a sensor nozzle to contain a thermal conductivity sensor, along with a pumping system to detect and analyze and identify gas concentration levels which are relayed to the controller and shown on a display screen.

Furthermore, in one embodiment, the sensing system includes a signal conditioning and data output unit to store a plurality of calibration data. Preferably, the signal conditional and data output unit includes a thermostabilizing system around a thermal conductivity sensor to improve the accuracy of specific gaseous concentration readings calculated from a thermal conductivity level reading. Moreover, a measurement chamber is contained within the housing of the sensing unit to encapsulate the thermal conductivity sensor in an air tight environment to allow the thermal conductivity sensor to maintain accurate readings over a range of gas concentrations from zero to one hundred percent. Additionally, the measurement chamber stabilizes a temperature of flowing through the sensing system to enable a more the gas accurate detection of the concentration of the gas.

In one embodiment, the measurement chamber includes an input cavity and a corresponding output cavity to allow for a flow of gas through the measurement chamber, thereby avoiding sample contamination and concentration fluctuation. Moreover, the measurement chamber seals off a portion of the signal conditioning and data output unit that houses the thermal conductivity sensor and corresponding surface mount heating resistors, which allows for all elements to enable sensing and detection of the gas concentration and thermal conductivity levels to be located the signal conditioning and data output unit to avoid any potential loss of signal.

In one embodiment, the sensing system further includes a pumping system, wherein the pumping system provides the ability for the sensing system to receive and take gas samples of a gas mixture from environments with ambient pressure. Furthermore, flowmeter with an associated flow valve is located on the outside of the housing and connected via a sensor nozzle to allow for a portion of an external flow of gas to be directed into the sensing system for detection and concentration analysis. In this setup, the flow of gas is controlled through the measurement chamber without increasing pressure; given that the thermal conductivity sensor may be sensitive to the gas pressure, maintaining flow control is crucial in order to prevent inaccurate readings and avoid damage to the thermal conductivity sensor.

Another object of the present disclosure is to provide a controller that is digitally connected to the sensing system and which includes a display screen to indicate the gas concentration detected by the sensing system; additionally, a series of buttons may be provided on a housing of the controller for various functions depending on the usage of the gas detection system. Furthermore, in some embodiments, a periodic one-point calibration adjusts a currently measured thermal may be performed which conductivity value to a known reference value, allowing the user to calibrate the sensing system to a pure gas mixture.

For example, the sensing system's measurement chamber is saturated with 100% O2. If the sensing system is reading a measured value of 0.0258 W/(m*K), and a reference value for O2 is calculated at 0.0263 W/(m*K), when a one-point calibration method is initiated for O2 the gas detection system takes the current measurement value and scales it by a correction factor (C) so that:

$$C * ( measured thermal conductivity ) = reference thermal conductivity$$

As a result, the measured thermal conductivity=0.0258 W/(m*K), the reference thermal conductivity=0.0263 W/(m*K), and C=0.0263/0.0258=1.019.

Furthermore, the correction factor is applied to the measured thermal conductivity value and resets either when the system is powered off or when the one-point calibration is run again. In a separate embodiment, a factory calibration utilizes 9 data points at 3 distinct concentrations to generate calibration values, which are permanent and persist through a power cycling. The one-point air-calibration is a correction which is utilized to adjust drift in thermal conductivity sensor values or change in environmental variables.

Referring now to the pumping system, in one embodiment, when an activation button is pressed and released, the pumping system turns on and stays on until the pump activation button is pressed and released again. Separately, in another embodiment, when the pump activation button is pressed, the pump turns on, but only as long as the button is held. When the button is released, the pump turns off.

As a result, the pump behavior may be toggled in a controller setting.

In yet another object of the present disclosure, the one-point air-calibration is performed via a processor in the controller. Upon completion of the calibration and generation of a set of calibration values, the set of calibration values is digitally transmitted to the sensing system and stored on a programmable memory located on the signal conditioning and data output unit. As such, in one embodiment, when a thermal conductivity level of a gas flowing through the sensing system is detected, the conductivity level is compared to the set of calibration values stored in the programmable member. In one embodiment, the set of calibration values may be a collection of different concentrations of Xenon and Oxygen gases which generate a thermal conductivity level. Therefore, it is possible to determine concentrations of gases that flow through the sensing system by determining the thermal conductivity level and comparing it to the set of calibration values.

In a preferred embodiment, a gas detection system and associated method is provided, wherein the gas detection system comprising a sensing system and associated controller in digital communication. In practice, the gas detection system allows for locating the sensing system near a gas source and conversely placing the controller in a separate location, thereby allow for use in multiple configurations, including but not limited to medical environments, harsh and hazardous environments.

In yet another embodiment, an analog to digital converter (“ADC”) chip located on the signal conditioning and data output unit may perform measurements of the thermal conductivity sensor to allow for calibration and accuracy across a full range of gas concentrations. As such, this configuration produces an increased resolution ranging from twelve to sixteen bit along with a better noise immunity. In contrast, the ADC provides for a smaller measurement range (±2.048 V), and by scaling down the thermal conductivity sensor via a voltage divider by approximately two-thirds, the ADC may be utilized and allows for a complete range of gas concentration measurements.

In another embodiment, a signal output from the thermal conductivity sensor may be an analog signal in the range of zero to five volts, wherein the voltage directly corresponds to the thermal conductivity of a gaseous mixture. As a result, if any noise is coupled into the analog signal, the noise is reflected in the measurement value. Furthermore, in order to prevent noise coupling into the signal over the digital connection between the sensing system the and controller, an analog measurement is converted into a digital signal via the ADC in the sensing system which may be digitally transmitted to the controller.

In yet another object of the present disclosure, the gas detection system provides maximum flexibility with regards to positioning of the sensing system and the controller by allowing a user to place the system in a harsh environment while maintain the ability to detect and read a measurement and control the pumping system from a safe distance.

There has thus been outlined, rather broadly, the more important features of a gas detection system and associated method, in order that the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction and to the arrangements of the components set forth in the following description, and/or illustrated in the drawings. The system is capable of other embodiments and of being practiced and carried out in various ways. Also, it is to be understood that the phraseology and terminology employed herein are for the purpose of description and should not be regarded as limiting.

These together with other objects of the system, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

The foregoing has outlined the more pertinent and important features of the present system in order that the detailed description of the system that follows may be better understood, and the present contributions to the art may be more fully appreciated. It is of course not possible to describe every conceivable combination of components and/or methodologies, but one of ordinary skill in the art may recognize that many further combinations or permutations are possible. Accordingly, the novel architecture described below is intended to embrace all such alterations, modifications, and variations that fall within the spirit and scope of the appended claims.

### BRIEF DESCRIPTION OF THE DRAWINGS

The invention may be more completely understood in consideration of the following detailed description of various embodiments of the invention in connection with the accompanying drawings, in which:

FIG. 1 illustrates a box diagram of the gas detection system.

FIG. 2 illustrates a perspective view of the sensing system and controller in digital communication.

FIG. 3A illustrates a top view of the thermal conductivity sensor in the sensing system.

FIG. 3B illustrates a perspective view of the thermal conductivity sensor prior to enclosure in the measurement chamber of the sensing system,

FIG. 3C illustrates a perspective view of the housing of the sensing system containing the measurement chamber, pumping system and signal conditioning and data output unit.

FIG. 4A illustrates an exemplary embodiment of a circuit diagram for a thermal management circuit.

FIG. 4B illustrates a graph for the thermal management circuit and provides a visual diagram of this cycle.

FIG. 5A illustrates an exemplary embodiment of a box diagram of the signal conditional and data output unit.

FIG. 5B illustrates a perspective view of the pumping system.

FIG. 6A illustrates an exemplary line graph displaying gas measurement values compared with the set of calibration values.

FIG. 6B illustrates an example of calibration data that corresponds to FIG. 6A.

FIG. 7 illustrates an exemplary circuit diagram of a constant excess temperature application circuit with a voltage divider used to generate a voltage corresponding to the thermal conductivity of a gas mixture, located on the signal conditioning and data output unit.

FIG. 8 illustrates a circuit diagram of an exemplary industry standard Wheatstone bridge.

FIG. 9A illustrates an exemplary circuit diagram of a constant excess temperature application circuit located on the signal conditioning and data output unit.

FIG. 9B illustrates graph showing that the thermal conductivity of a gas is proportional to the output voltage of the constant excess temperature application circuit.

FIG. 10 illustrates an exemplary circuit diagram of a temperature measurement circuit utilizing a voltage divider to generate a voltage corresponding to the ambient temperature of a gas, located on the signal conditioning and data output unit.

FIG. 11 illustrates a box diagram of the housing of the controller with a processor and push buttons.

FIG. 12A illustrates a perspective view of the assembled controller,

FIG. 12B illustrates a side view of the controller.

FIG. 12C illustrates a front view of the controller.

FIG. 13 illustrates an exemplary line graph comparing measured gas concentration versus stored concentration values.

FIGS. 14A-14M illustrate an alternative embodiment of the gas detection system with the sensing system and controller.

FIG. 15 illustrates a flow diagram of a method for detecting the concentration of gas utilizing the gas detection system.

### DETAILED DESCRIPTION OF THE SEVERAL EMBODIMENTS

The detailed description set forth below in connection with the appended drawings is intended as a description of several embodiments of the apparatus and does not represent the only forms in which the present apparatus may be constructed and/or utilized. The description sets forth the functions and the sequence of steps for constructing and operating the apparatus in connection with the illustrated embodiments. However, it is to be understood that the same or equivalent functions and sequences may be accomplished by different embodiments that are also intended to be encompassed within the spirit and scope of the invention.

For the following defined terms, these definitions shall be applied, unless a different definition is given in the claims or elsewhere in this specification. All numeric values are herein assumed to be modified by the term “about”, whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following description should be read with reference to the drawings wherein like reference numerals indicate like elements throughout the several views. The drawings, which are not necessarily to scale, depict illustrative embodiments of the claimed invention.

Reference will now be made to non-limiting embodiments, examples of which are illustrated in the Figures.

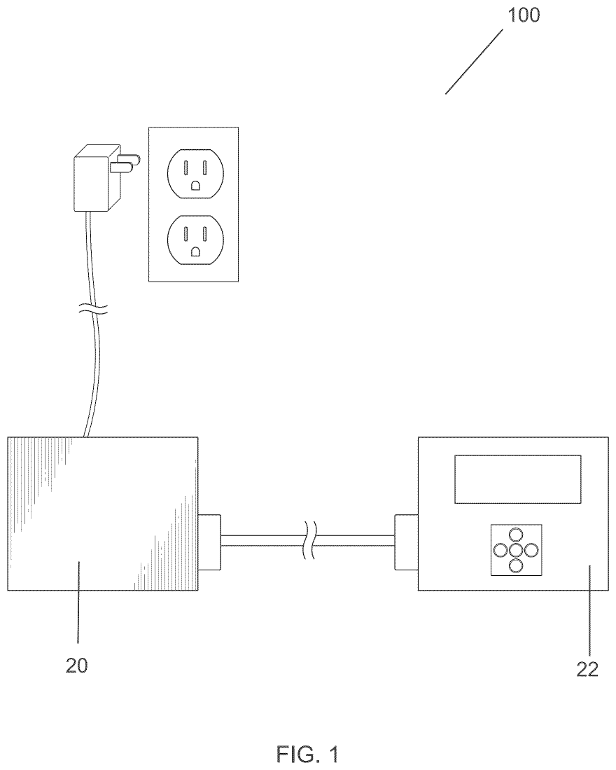

FIG. 1 illustrates a box diagram of a gas detection system 100, wherein the gas detection system 100 preferably comprises a sensing system 20 and a controller 22 that are in digital communication. The sensing system 20 may be powered through conventional power means through a standard electrical outlet or similar means.

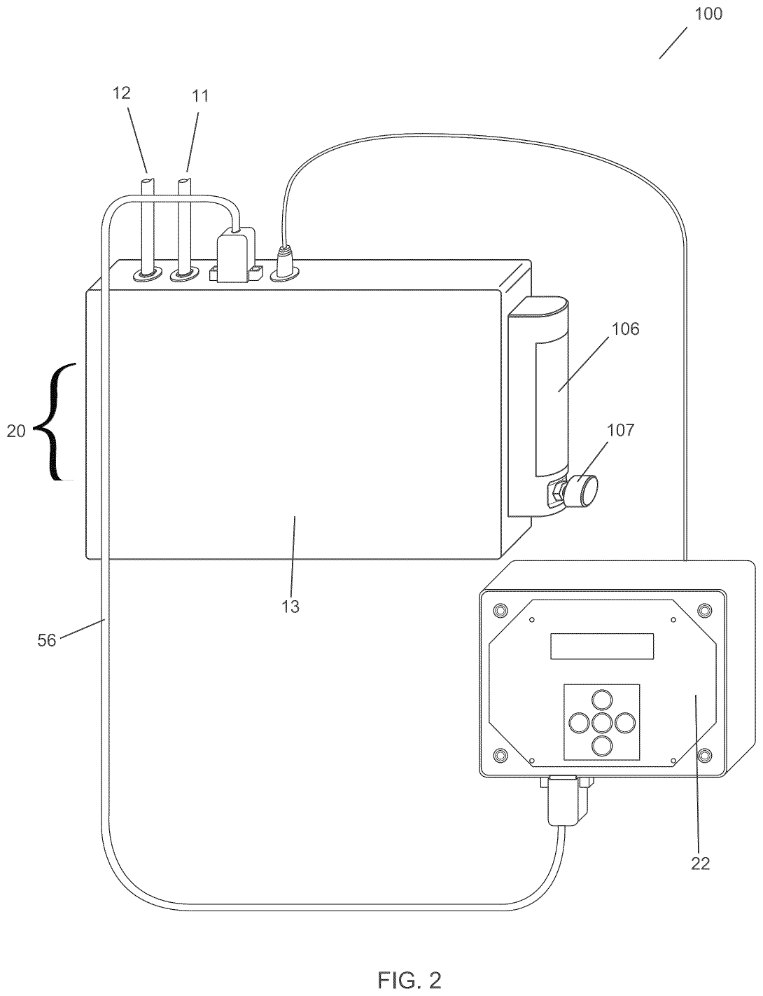

FIG. 2 illustrates a perspective view of the gas detection system 100, wherein the sensing system 20 may be easily connected to an outside gas delivery system (not shown) via an ingress tube 12 and an egress tube 11 on a housing 13 of the sensing system 20. In one embodiment, the gas detection system 100 preferably generates a percentage of xenon or other gas; wherein the percentage is in a binary mixture of xenon or another gas, and oxygen. In this configuration, a concentration of gas connected to the gas detection system 100 in real-time.

Preferably, the sensing system 20 is in digital communication with the controller 22 via an I2C Bus 56 or similar connection means. Additionally, a flowmeter 106 is located on an outside of the housing 13 of the sensing system 20, wherein the flowmeter 106 includes a flow valve 107 to regulate a flow of gas through the sensing system 20.

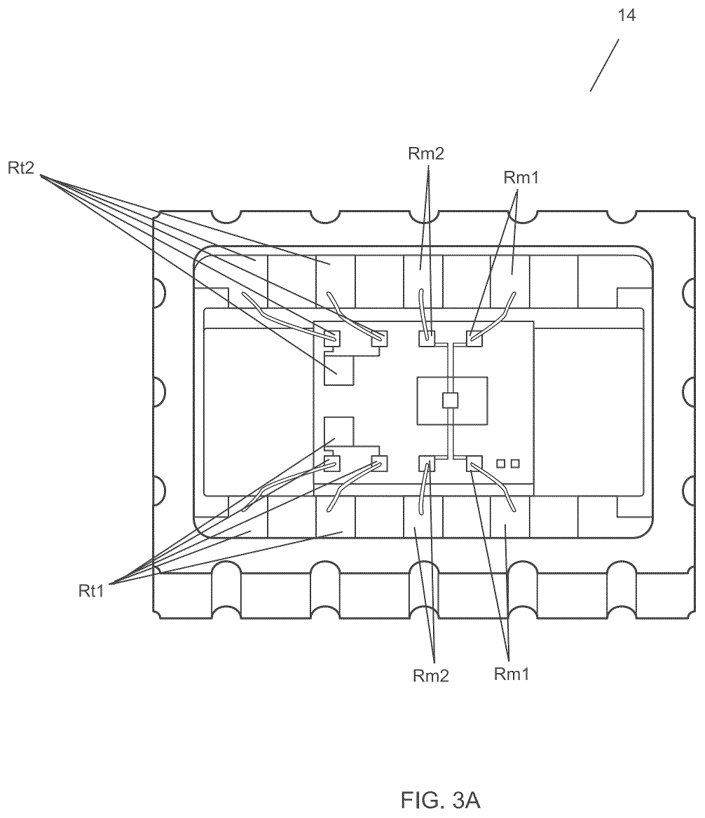

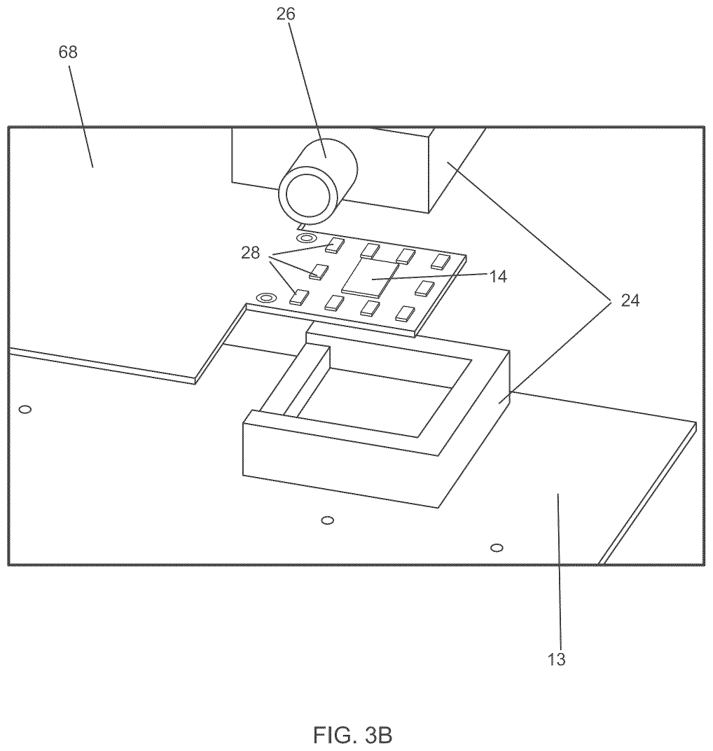

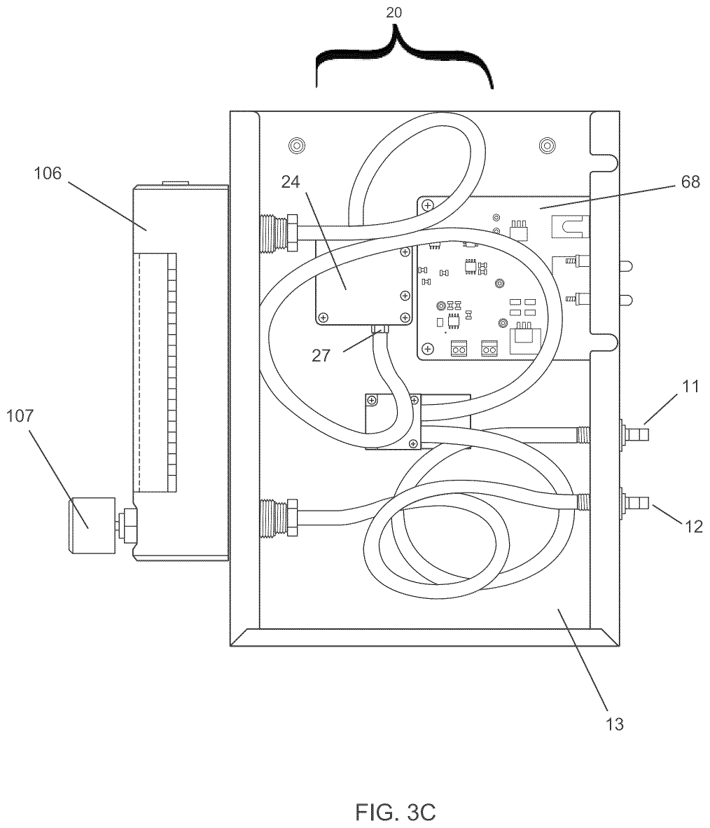

FIG. 3A illustrates a thermal conductivity sensor 14, wherein the thermal conductivity sensor 14 is located on a signal conditional and data output unit 68 (see FIG. 3B) in the sensing system 20. Preferably the thermal conductivity sensor 14 is utilized to detect a thermal conductivity level of a gas flowing through the gas detection system 100. Furthermore, internal resistors Rm1, Rm2, Rt1, and Rt2 comprise the thermal conductivity sensor 14.

FIG. 3B illustrates a partial view of the housing 13 of the sensing system 20, wherein a measurement chamber 24 is located on the housing 13 and is configured to receive the thermal conductivity sensor 14. The measurement chamber 24 encloses the thermal conductivity sensor 14 to create an airtight seal and environment to allow for the thermal conductivity sensor 14 to detect a concentration of gas introduced into the gas detection system 100. In this embodiment, a series of surface mount heating resistors 28 surround the thermal conductivity sensor 14 on the signal conditioning and data output unit 68. In this embodiment, the air tight environment of the measurement chamber 24 prevents the introduction of any air which would impact the accuracy of the gas detection system 100.

FIG. 3C illustrates the sensing system 20 with the housing 13 containing the measurement chamber 24 and the signal conditioning and data output unit 68. In this embodiment the measurement chamber 24 further comprises two ports, an input port 26 and an output port 27, wherein the pair of ports 26, 27 allow for gas flow through the ingress tube 12 and egress tube 11 in the measurement chamber 24. Additionally, the series of surface mount heating resistors 28 are disposed regulate an internal temperature of the measurement chamber 24. In this embodiment, internal resistors Rt1, Rt2, Rm1, and Rm2 are located inside of the thermal conductivity sensor as shown in various circuit diagrams (see FIG. 3A). In one embodiment, a temperature of the measurement chamber 24 may be kept at or substantially around fifty degrees Celsius. In this preferred embodiment, the stabilization of the temperature in the measurement chamber 24 allows for obtaining a consistent gas concentration measurement irrespective of the surrounding temperature in the environment where the gas detection system 100 is deployed and/or the temperature of the gas flowing through the gas detection system 100.

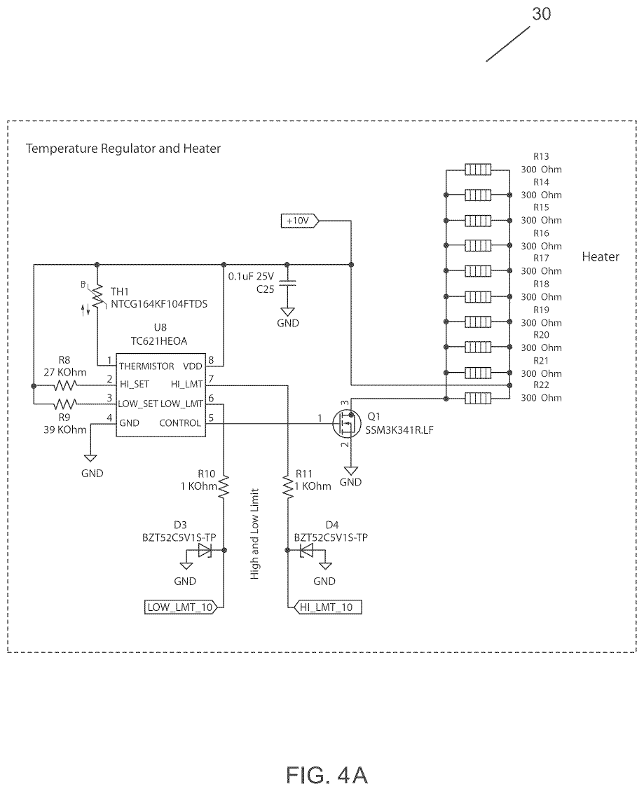

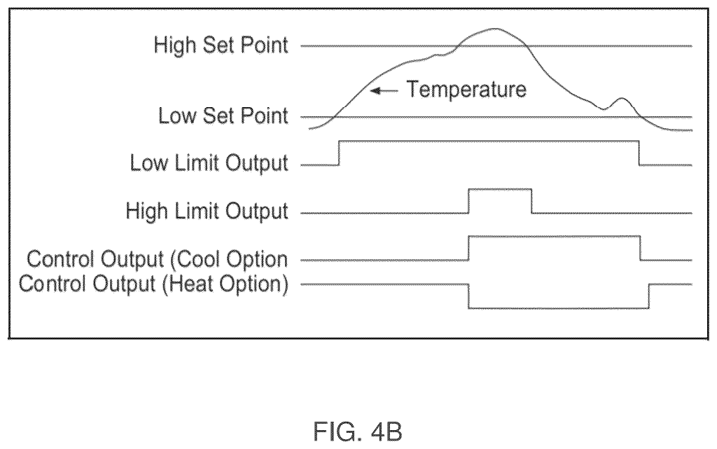

FIG. 4A illustrates an exemplary circuit diagram of a thermal management circuit 30, wherein the thermal management circuit 30 heats up the surface-mount heating resistors 28 and is responsible for stabilizing an ambient temperature of the gas in the measurement chamber 24 to a constant value, before it is exposed to the thermal conductivity sensor 14 and heated to an excess temperature for measurement. The thermal management circuit 30 is an additional stabilization method for measurement consistency.

An integrated circuit contained within the thermal management circuit 30, is a dual trip point temperature sensor that regulates the series of surface mount heating resistors 28 on and off based on a user-selected temperature set points. Furthermore, the integrated circuit includes a set of output signals when a measured temperature is above or below the temperature set points.

Furthermore, the thermal management circuit 30 further comprises (1) TH1 that is a negative temperature coefficient thermistor and serves as a temperature detection component, (2) R8 that sets the high temperature limit of the thermal management circuit 30 at around 55° C., (3) R9 that sets the low temperature limit of the thermal management circuit 30 at around 45° C., (4) C25 that serves as a general decoupling capacitor used for stability, (5) the plurality of surface-mount heat resistors 28 annotated as R13-R22, (6) Q1 which is a metal-oxide-semiconductor field-effect transistor (MOSFET) 42 that switches power to the series surface mount heating resistors 28 and switches on when temperature is below the low temperature limit and off when a temperature is above the high temperature limit, and (7) resistors R10 and R11 and 5V Zener diodes D3 and D4 ensures that a high temperature limit and a low temperature limit signals that go to a general purpose input/output (GPIO) are around 5V max, so that the high temperature limit and the low temperature limit signals do not damage plurality of GPIO pins.

Furthermore, the thermal management circuit 30 operates in a cycle, wherein at cycle start, an ambient temperature in the gas measurement chamber 24 is below the low temperature limit set at 45° C. The metal-oxide-semiconductor field-effect transistor 42 activates and 10V is applied to the series of surface mount heating resistors 28, wherein the series of surface mount heating resistors 28 dissipate power in the form of heat, causing the measurement chamber 24 to heat up. The measurement chamber 24 continues heating until a temperature passes the high temperature limit, set at 55° C., Next, the metal-oxide-semiconductor field-effect transistor 42 turns off, and the series surface mount heating resistors 28 cool off until a temperature in the measurement chamber 24 drops in temperature below 45° C. Finally, the metal-oxide-semiconductor field-effect transistor 42 activates again, and the measurement chamber 24 heats up. This cycle continues as long as the gas detection system 100 is powered on.

FIG. 4B illustrates a graph for the thermal management circuit 30 and provides a visual diagram of this cycle,

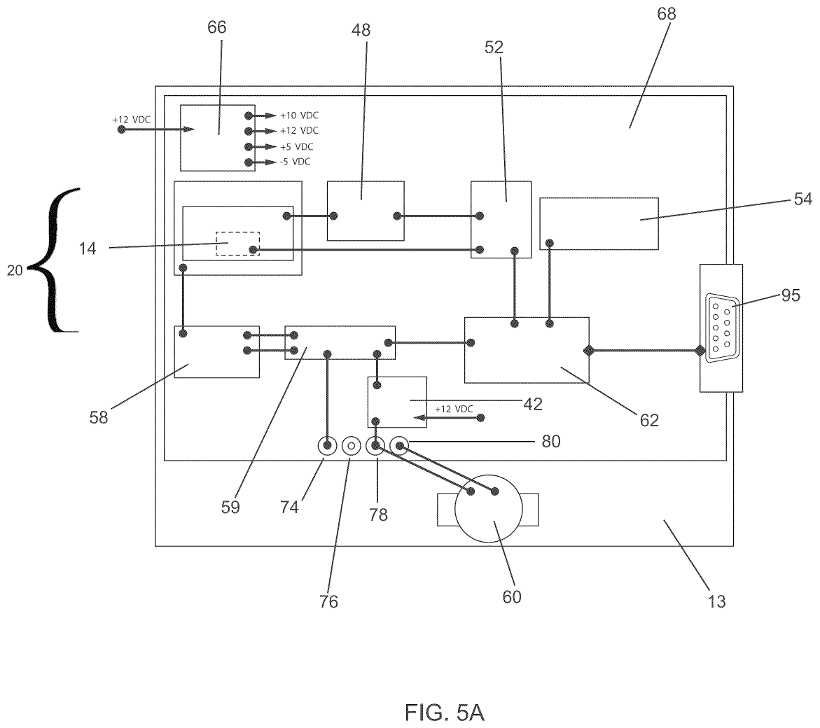

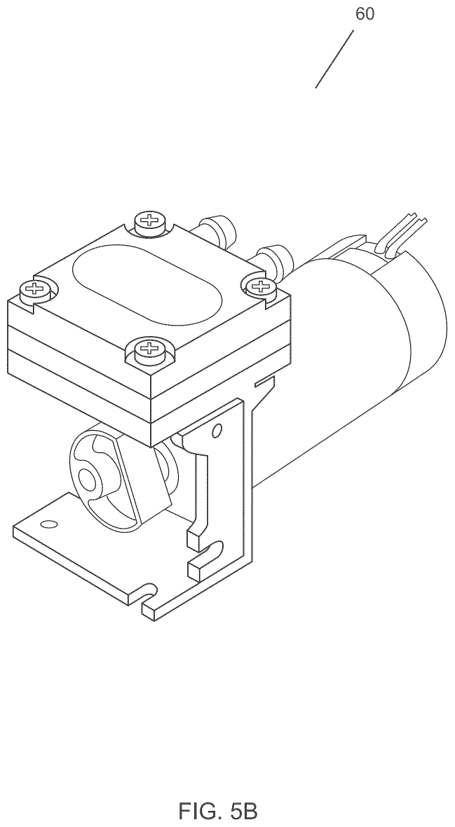

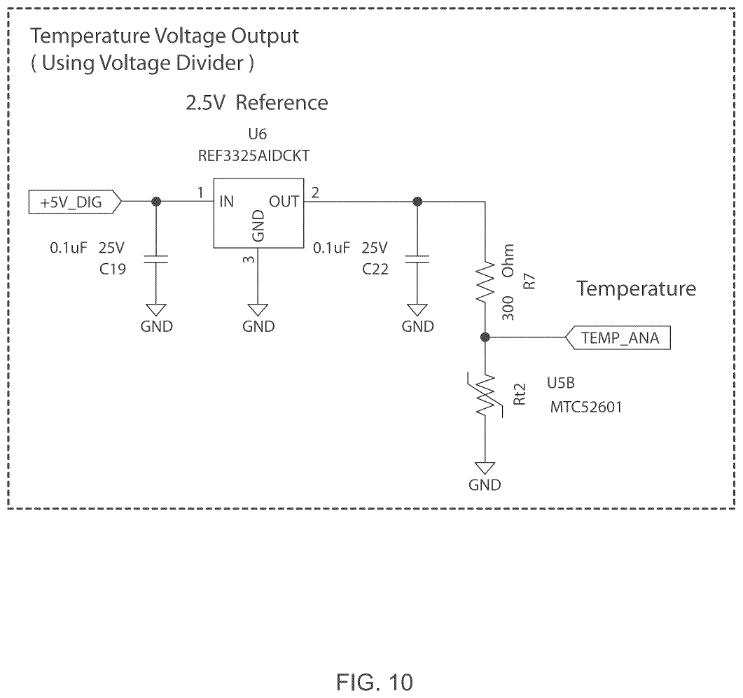

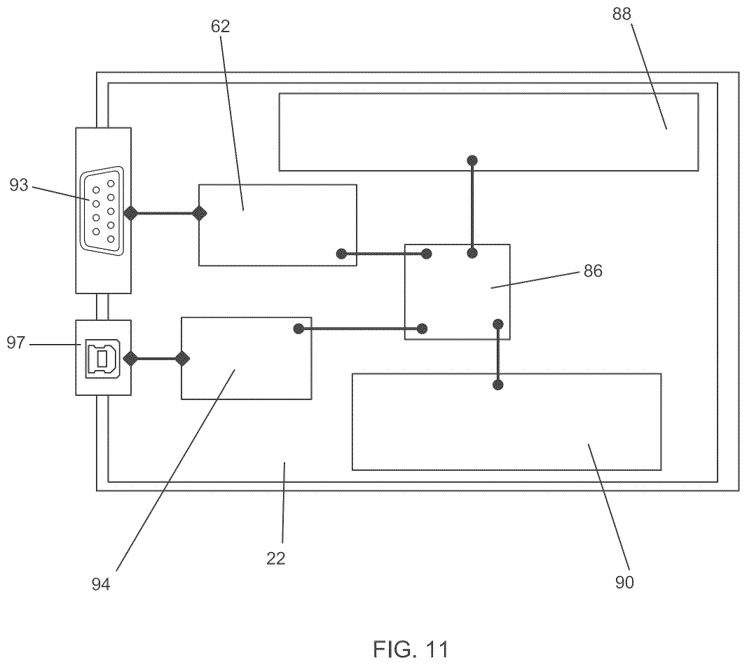

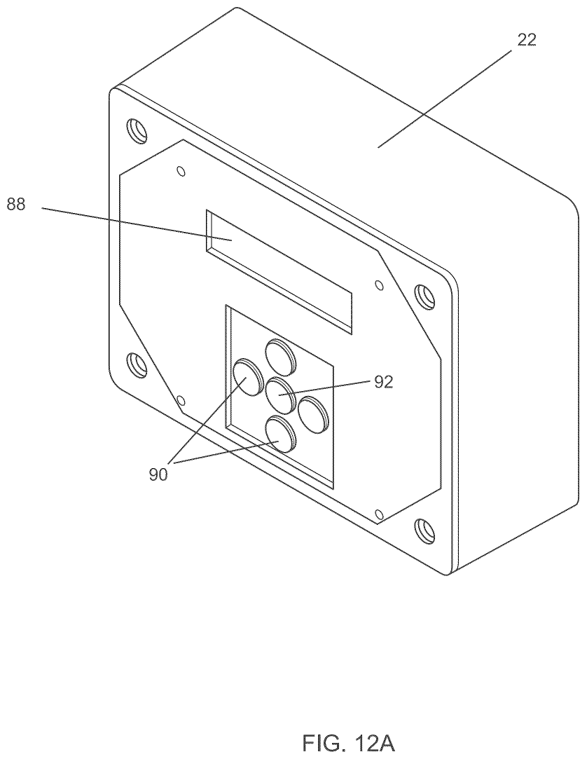

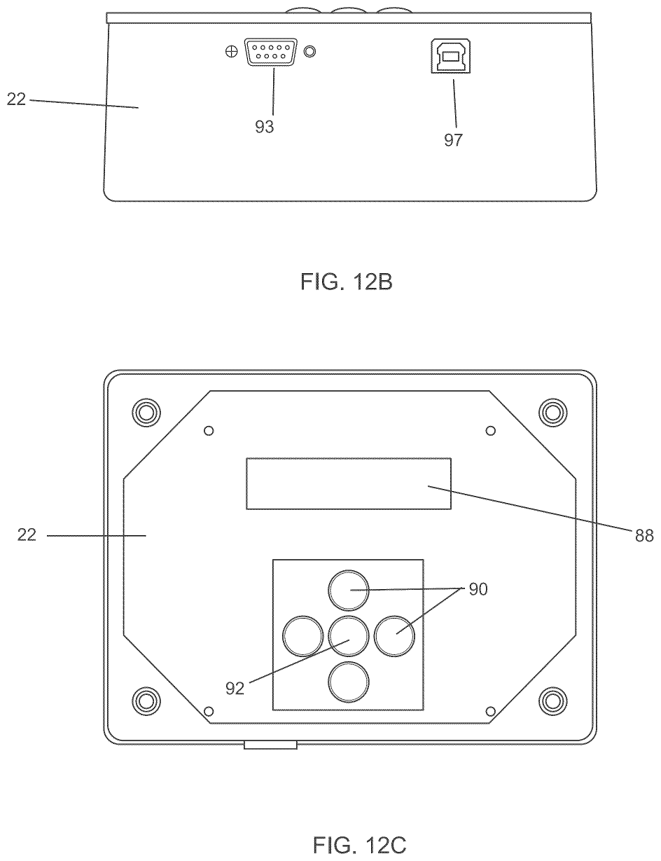

FIG. 5A illustrates the signal conditioning and data output unit 68 located in the sensing system 20; in this figure the dotted line represents the thermal conductivity sensor 14. Preferably, an analog-to-digital (“ADC”) Converter 52 is configured to convert an analog voltage output of the thermal conductivity sensor 14, generated via the excess temperature application circuit 96, and an analog voltage output of the temperature sensing circuit (see FIG. 10) into a digital signal, via an inter-integrated circuit (I2C) to send to a processor 86 (see FIG. 11) in the controller 22. In this embodiment, the conversion from the ADC is utilized in place of transmitting an actual analog voltage to eliminate any potential issues with noise that could couple into an analog signal between the digital communication of the sensing system 20 and the controller 22.

Furthermore, a programmable memory 54 is provided on the signal conditioning and data output unit, wherein the programmable memory 54 stores identifying parameters of the sensing system 20, such as Revision, serial number, a check byte that indicates whether the sensing system 20 has been calibrated or not, along with the set of calibration values. The controller 22 is configured to interpret these parameters and use the various calibration parameters to calculate gas concentrations of gaseous mixtures by determining the gaseous mixture's thermal conductivity level. The thermal conductivity level is then converted into a percentage. After that, the percentage is multiplied by a first calibration constant and added to a second calibration constant to get a final, calibrated measurement. Calibration data that is stored includes the first calibration constant and the second calibration constant.

In one embodiment, calibration begins after the measurement of thermal conductivity of a gas mixture. Specifically, calibration starts with a two-step process to account for variance in the thermal conductivity sensor 14 parameters, specifically the internal resistors Rt1, Rt2, Rm1, and Rm2. Step one normalizes the thermal conductivity reading from the sensing system 20 to the thermal conductivity of a known gas. This process is exactly the same as the one-point calibration process discussed earlier. The second step then fits the measurement output of the sensing system 20 to nine calibration points of a binary gas mixture via linear regression.

The nine calibration points consist of three points at 0% Xe/100% O2, three points at 50% Xe/50% O2 and three points at 100% Xe/0% O2. By performing linear regression between the measured values and the known values, a preferred embodiment adjusts the measured values to match the known values. This provides two calibration constants: one for a slope of a line and one for an offset. A calibrated output equation may be shown as follows:

$$Calibrated percentage = a * ( measured percentage ) + b$$

Furthermore, the programmable memory 54 communicates digitally with the processor 86 via I2C bus 56 and has a maximum limit for calibration. Preferably the set of calibration values is stored between pairs of gases and corresponding software may be generated to handle up to twelve gases; therefore, 66 unique gas concentrations

$$( ( \begin{matrix}12 \\ 2\end{matrix} ) ) .$$

The gas detection system 100 differentiates between gases with a significant difference in thermal conductivities. For example, the gas detection system 100 distinguishes between Xe (5.5 mW/m*K) and N2 (25.9 mW/m*K, while challenging to distinguish between N2 and O2 (26.3 mW/m*K). Therefore, the accuracy and usefulness of the gas detection system 100 depends on relative thermal conductivities of the gases in a mixture.

A general-purpose input/output (GPIO) expander 59 may be included in the signal conditioning and data output unit 68 to increase measurement and control capabilities on the sensor, GPIO expander 59 is located on the sensor board 68 and provides four separate GPIOs, a first GPIO pin 74, a second GPIO pin 76, a third GPIO pin 78, and a fourth GPIO pin 80, that are controlled via the controller 22. The first GPIO pin 74 and the fourth GPIO pin 80 are set inputs, in order to monitor whether an ambient temperature in the measurement chamber 24 has hit a high limit or a low limit. The third GPIO pin 78 is set as an output and is used to control MOSFET 42 to switch on and off a pumping system 60 (see FIG. 5B). The analog-to-digital converter (ADC) 52, the GPIO expander 59, and the programmable memory 54 are all connected to an I2C bidirectional buffer 62, which allows for communication with the controller 22. The general-purpose input/output expander 59 further monitors the high temperature limit and low temperature limit signals from a temperature controller 58 and provides a control signal for the pumping system 60. General purpose input/output expander 59 also communicates with the processor 86, digitally, via the I2C bus 56.

A control signal from a general-purpose input/output does not provide enough power to operate the 12V pump 60 by itself. So, instead, the control signal operates the metal-oxide semiconductor field-effect transistor (MOSFET) 42, which switches the pumping system 60 between an on and off position.

The I2C Bidirectional Buffer 62 helps transmit an I2C signal, typically designed for board-level use, via the I2C bus 56 between the sensing system 20 and the controller 22.

A voltage regulator 66 is provided on the signal conditioning and data output unit 68 that may comprise three different voltage regulators that provide various voltage levels. A first voltage regulator regulates a 12 volts direct current (VDC) power supply to a 10 VDC. A second voltage regulator regulates the 12 VDC power supply to a 5 VDC. A third voltage regulator regulates the 5 VDC power supply to a −5V. As stated earlier, these voltages are used to power different components of the system. For instance, 12 VDC is used to power the pumping system 60; 10 VDC is used to power the plurality of surface mount heating resistors 28 and a 5 VDC is used to power integrated currents and the processor 86 in the controller 22.

Referring specifically to FIG. 5B, the metal-oxide-semiconductor field-effect transistor (MOSFET) 42 is used to drive a pumping system 60.

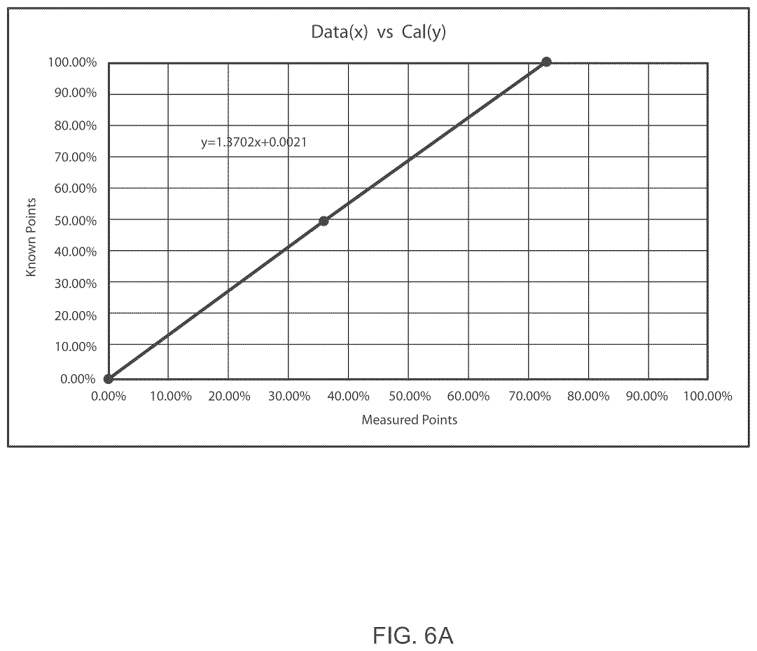

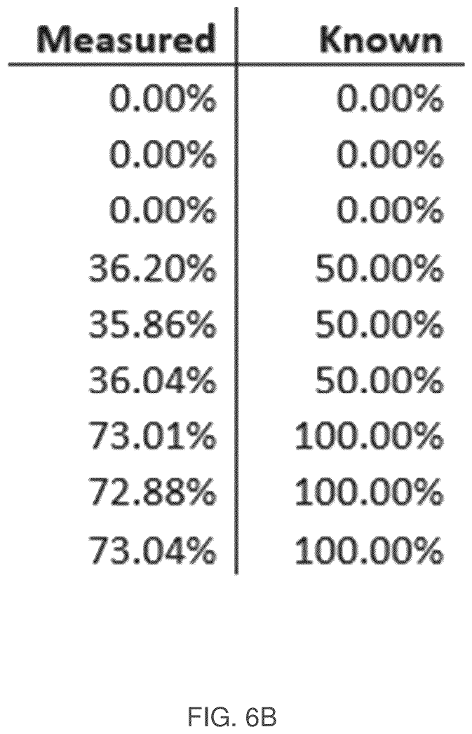

FIG. 6A illustrates an exemplary line graph displaying gas measurement values compared with the set of calibration values.

FIG. 6B illustrates an example of calibration data that corresponds to FIG. 6A.

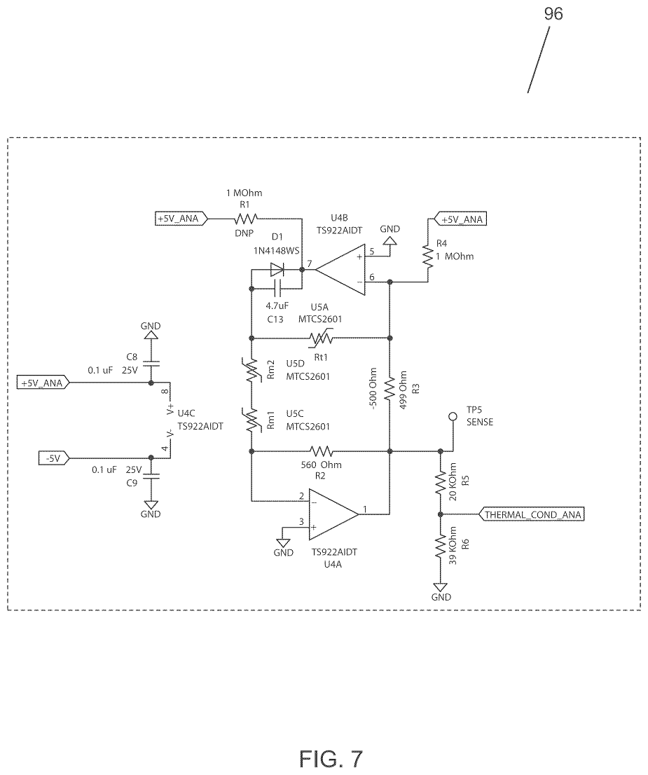

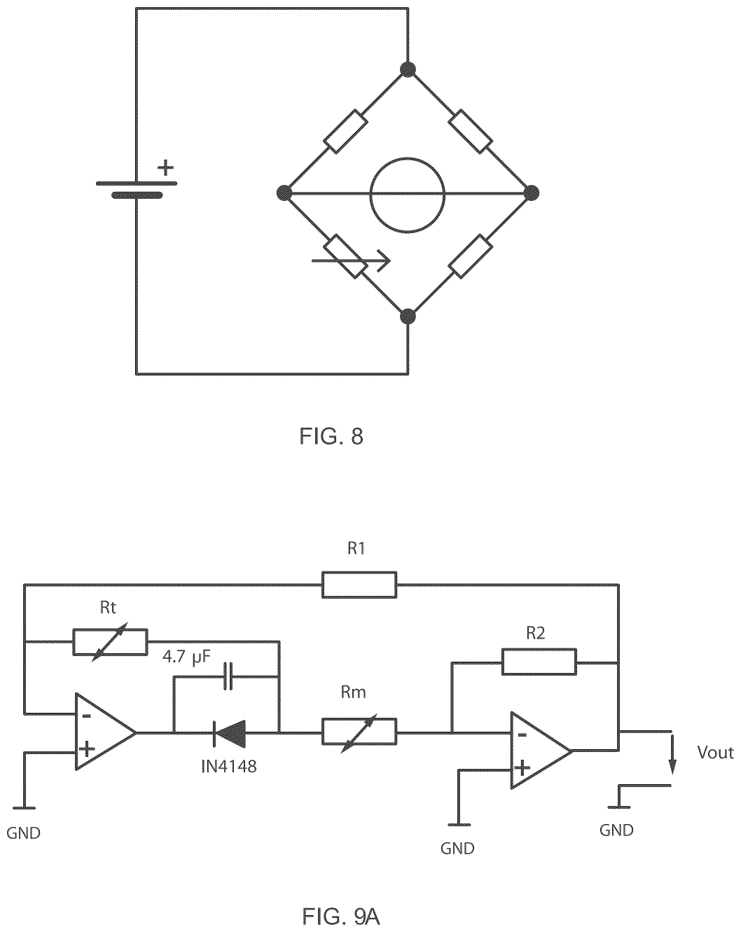

FIG. 7 illustrates a constant excess temperature application circuit 96 that works via heating two of the internal resistors Rm1 and Rm2 within the thermal conductivity sensor 14 above the ambient temperature in the gas measurement chamber 24 via the feedback loop. As Rm1 and Rm2 heat up, their resistance increases, until the feedback loop is stable. The amount that the internal resistors Rm1 and Rm2 heat up above ambient temperature remains constant, and the power needed to maintain an excess temperature depends on a thermal conductivity of the gas mixture that the thermal conductivity sensor 14 is exposed to. This provides an analog voltage output of the constant excess temperature application circuit 96. The analog voltage output signal, after being scaled down by the voltage divider, is referred to as THERMAL_COND_ANA (see FIG. 7).

The other two internal resistors (Rt1, Rt2) within the thermal conductivity sensor 14 change resistance based on the ambient temperature of the gas mixture in the gas measurement chamber 24.

Internal resistor Rt1 is used within the constant excess temperature application circuit 96 to compensate for the effect of ambient temperature on a measurement. This is referred to as temperature compensation.

Internal resistor Rt2 is used in a separate temperature measurement circuit (see FIG. 10) in order to provide an analog voltage output for the temperature in the gas measurement chamber 24, referred to as TEMP_ANA (see FIG. 10).

The analog voltage output of the constant excess temperature application circuit 96, prior to being scaled down by the voltage divider, is calculated as follows:

$${V}_{out} = \sqrt{λ * \frac{G * R 2 * ( R 2 * Rt {1}_{0} - R 3 * ( Rm {1}_{0} + Rm {2}_{0} ) )}{a * Rt {1}_{0} * ( Rm {1}_{0} + Rm {2}_{0} )}}$$

Where:
Vₒᵤₜ is the output voltage from the constant excess temperature application circuit 96, prior to being scaled down by the voltage divider
λ is the thermal conductivity of the gas
G is the geometry factor of the thermal conductivity sensor 14 (given as a constant in the MTCS2601 datasheet as 3.9 mm).
α is the temperature coefficient of Rm and Rt (given as a constant in the MICS2601 datasheet as 0.0055° C.⁻¹).
R2 and R3 are the values of the different resistors within the constant excess temperature application circuit 96. In this implementation, R2=560Ω, R3=499Ω.
Rt1₀, Rm1₀, and Rm2₀ are the values of the resistors within the MTCS2601 at 0° C. The MICS2601 datasheet provides the below formulas to calculate these values:

$$\begin{matrix}Rt {1}_{0} = \frac{Rt 1 ( T )}{1 + α * T} \\ Rm {1}_{0} = \frac{R m 1 ( T )}{1 + α * T} \\ Rm {2}_{0} = \frac{Rm 2 ( T )}{1 + α * T}\end{matrix}$$

Rt1 (23° C.)=270Ω
Rm1 (23° C.)=Rm2 (23° C.)=120Ω.

This allows us to calculate:

$$\begin{matrix}Rt {1}_{0} = \frac{270}{1 + 0.0055 * 23} = 239.6804 Ω \\ Rm {1}_{0} = Rm {2}_{0} = \frac{120}{1 + 0.0055 * 23} = 106.5246 Ω\end{matrix}$$

Now rearranging the equation:

$$\begin{matrix}{V}_{out} = \sqrt{λ * \frac{G * R 2 * ( R 2 * Rt {1}_{0} - R 3 * ( Rm {1}_{0} + Rm {2}_{0} ) )}{α * Rt {1}_{0} * ( Rm {1}_{0} + Rm {2}_{0} )}} \\ {( {V}_{out} )}^{2} = λ * \frac{G * R 2 * ( R 2 * Rt {1}_{0} - R 3 * ( Rm {1}_{0} + Rm {2}_{0} ) )}{α * Rt {1}_{0} * ( Rm {1}_{0} + Rm {2}_{0} )} \\ λ = {( {V}_{out} )}^{2} * \frac{α * Rt {1}_{0} * ( R m {1}_{0} + Rm {2}_{0} )}{G * R 2 * ( R 2 * Rt {1}_{0} - R 3 * ( Rm {1}_{0} + Rm {2}_{0} ) )}\end{matrix}$$

Substituting known values into the equation, we get:

$$λ = {( {V}_{out} )}^{2} \frac{0.0055 * 239.6804 * ( 106.5246 + 106.5246 )}{0.0039 * 560 * ( 560 * 239.6804 - 499 * ( 106.5246 + 106.5246 ) )}$$

And so, the thermal conductivity can be found by calculating:

$$λ = 0.0046075634858 * {V}_{out}^{2}$$

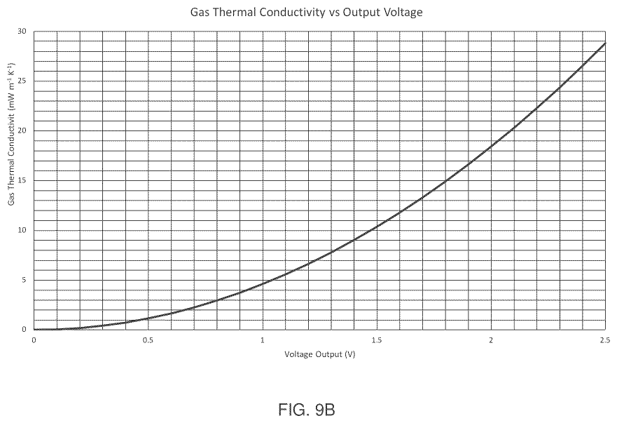

FIG. 9B illustrates that the thermal conductivity of the gas is proportional to the output voltage of the constant excess temperature application circuit 96, squared.

FIG. 10 illustrates a temperature measurement circuit. Specifically, U6 is a voltage regulator that provides a constant 2.5 V at an output 50. C19 and C22 are capacitors that stabilize an input and output voltages of a voltage regulator U6. Furthermore, R7 is a 300-ohm resistor that forms one half of a voltage divider. A voltage divider is a circuit that produces an output voltage dependent on a relative resistance of two resistors. Rt2 is an internal resistor located within the thermal conductivity sensor 14, that forms another half of the voltage divider. This circuit gives a voltage output proportional to the resistance of Rt2, which in turn depends on an ambient temperature of the gaseous mixture in the gas measurement chamber 24. As a result, this gives us an analog temperature signal, referred to as TEMP_ANA (see FIG. 10). The analog voltages from the constant excess temperature application circuit 96 (THERMAL_COND_ANA) and the temperature measurement circuit (see FIG. 10) (TEMP_ANA) are then converted from an analog signal to a digital signal using the analog-to-digital converter (ADC) 52, so that the controller 22 may process the data.

FIG. 11 illustrates a box diagram of the controller 22, wherein the controller 22 is primarily responsible for system control of the gas detection system 100 along with displaying information to user, and accepting user input. The controller 22 includes the processor 86, which calculates a xenon or other gas percentage and the ambient gas temperature based on voltage signals transmitted from the sensing system 20. A display screen 88 is utilized to visually illustrate to a user of the gas detection system 100 the gas concentrations. The controller 22 also reads inputs from a set of push buttons 90, allowing the user to activate the pumping system 60 and enable other features. One of these other features is an advanced display option, which prints a resistance measurement of Rt2 (see FIG. 3A) and the voltage output of the Constant excess temperature application circuit 96 to the display screen 88, in addition to normally displayed parameters. Another feature is pumping system 60 latching option, which allows the user to choose whether the set of push buttons 90 needs to be engaged for the pumping system 60 to run continuously or whether the set of push buttons 90 only need to be pressed one time for the pumping system 60 to run continuously. For either option, the pumping system 60 may be started and stopped by pressing the center button 92 of push buttons 90.

The controller 22 also contains the I2C bidirectional buffer 62 that allows for communication with the sensing system 20, a COM connector 93 which corresponds to a COM connector 95 on the sensing system 20, and a USB serial to RS232 serial converter 94, to program the microcontroller 86. Furthermore, the processor 86 is programmed when the processor 86 connects to a serial converter 94, which connects directly to a USB port 97 on the controller 22. The USB port 97 then connects directly to a computing system, and a code may be uploaded to the processor 86 via an IDE such as the Arduino IDE.

As discussed above, the thermal conductivity is given by:

$$λ = {V}_{out}^{2} * 0.004607563$$

Or equivalently:

$${V}_{out} = \sqrt{\frac{λ}{0.004607563}}$$

Therefore, the following table corresponds to a thermal conductivity:

| | Thermal |
|---|---|
| Voltage Output | Conductivity |
| of circuit | (mW/(m*K)) |
| 0.0 | 0.000000 |
| 0.5 | 1.151891 |
| 1.0 | 4.607563 |
| 1.5 | 10.367018 |
| 2.0 | 18.430254 |
| 2.5 | 28.797272 |
| 3.0 | 41.468071 |
| 3.5 | 56.442853 |
| 4 | 73.721018 |
| 4.5 | 93.303161 |
| 5.0 | 116.189087 |

Furthermore, the following table presents thermal conductivities for selected gases at 300 K (26.85 C) and their resulting voltages:

| | Thermal | |
|---|---|---|
| | Conductivity | Voltage output |
| Gas | (mW/(m*K)) | of sensor (V) |
| Air | 26.4 | 2.394 |
| O2 | 26.5 | 2.398 |
| N2 | 26.0 | 2.375 |
| CO2 | 16.8 | 1.909 |
| Xe | 5.5 | 1.092 |
| Ar | 17.7 | 1.960 |
| Ne | 49.4 | 3.274 |
| SF6 | 13.0 | 1.680 |
| H2 | 186.6 | 6.364 |

In this embodiment, given a 5V supply, measurements up to 115 mW/(m*K) are compatible. Usage of a MCP3426A0T-E/SN as an ADC, at a PGA of 1 and a resolution of 16 bits is utilized. These settings allow the ADC to measure a range between −2.048 V and 2.0479375 V. This corresponds to a maximum thermal conductivity of 19.3 mW/(m*K). In order to account for a reduced range, a voltage divider is used to scale signals down into the ADC's measurement range. A voltage divider is used to scale down the constant excess temperature circuit's 96 output by ˜⅔rds. This provides the ability to effectively increase the range of the thermal conductivity sensor 14 and allowing measuring thermal conductivities up to ˜41 mW/(m*K)); while still reducing a range from an ideal 5V. A table demonstrating the result is below:

| | Thermal | | | |
|---|---|---|---|---|
| | Conductivity | Voltage output | Scaled voltage | In range of |
| Gas | (mW/(m*K)) | of sensor (V) | output. | ADC? |
| Air | 26.4 | 2.394 | 1.596 | Yes |
| O2 | 26.6 | 2.398 | 1.599 | Yes |
| N2 | 26.0 | 2.375 | 1.584 | Yes |
| CO2 | 18.8 | 1.909 | 1.273 | Yes |
| Xe | 5.5 | 1.092 | 0.728 | Yes |
| Ar | 17.7 | 1.960 | 1.307 | Yes |
| Ne | 49.4 | 3.274 | 2.183 | No |
| SF6 | 13.0 | 1.680 | 1.120 | Yes |
| H2 | 186.6 | 6.364 | 4.242 | No |

In an embodiment with a binary gas mixture, the thermal conductivity of the gas mixture is used to determine a ratio of two gases. In a preferred embodiment, the two gases are xenon or other gas and oxygen.

A thermal conductivity gauge equation for the thermal conductivity of a binary gas mixture is produced:

$${λ}_{mix} = \frac{x * {λ}_{1}}{x + ( 1 - x ) * {F}_{12}} + \frac{( 1 - x ) * {λ}_{2}}{( 1 - x ) + x * {F}_{21}}$$

Where:
x is the fraction of xenon or other gas in the mixture.
λ_{miz} is the thermal conductivity of the binary mixture.
λ₁ and λ₂ are the thermal conductivities of xenon or other gas and oxygen.
F₁₂ and F₂₁ are constants given by:

$$\begin{matrix}{F}_{12} = {[ 8 * ( 1 + \frac{{M}_{1}}{{M}_{2}} ) ]}^{- 0.5} * {[ 1 + {( \frac{{μ}_{1}}{{μ}_{2}} )}^{0.5} * {( \frac{{M}_{2}}{{M}_{1}} )}^{0.25} ]}^{2} \\ {F}_{21} = {[ 8 * ( 1 + \frac{{M}_{2}}{{M}_{1}} ) ]}^{- 0.5} * {[ 1 + {( \frac{{μ}_{2}}{{μ}_{1}} )}^{0.5} * {( \frac{{M}_{1}}{{M}_{2}} )}^{0.25} ]}^{2}\end{matrix}$$

M₁, M₂ are the molecular weights of xenon or other gas and oxygen.
μ₁, μ₂ are the dynamic viscosities of xenon or other gas and oxygen respectively.

The thermal conductivity equation above can be rearranged to form a quadratic equation in the form:

$${ax}^{2} + bx + c = 0$$

Where:

$$\begin{matrix}a = - {λ}_{mix} * ( 1 - {F}_{21} ) * ( 1 - {F}_{12} ) + {λ}_{1} * ( 1 - {F}_{21} ) + {λ}_{2} * ( 1 - {F}_{12} ) \\ b = {λ}_{mix} * ( 1 - 2 {F}_{12} + {F}_{12} {F}_{21} ) - {λ}_{1} + {λ}_{2} * ( 2 {F}_{12} - 1 ) \\ c = {F}_{12} * ( {λ}_{mix} - {λ}_{2} )\end{matrix}$$

A fraction of xenon or other gas is then found by using the quadratic formula:

$$x = \frac{- b + \sqrt{{b}^{2} - 4 ac}}{2 a}$$

This allows directly relating the concentration of xenon or other gas to the thermal conductivity of the gas sample.

### Validation Data Example

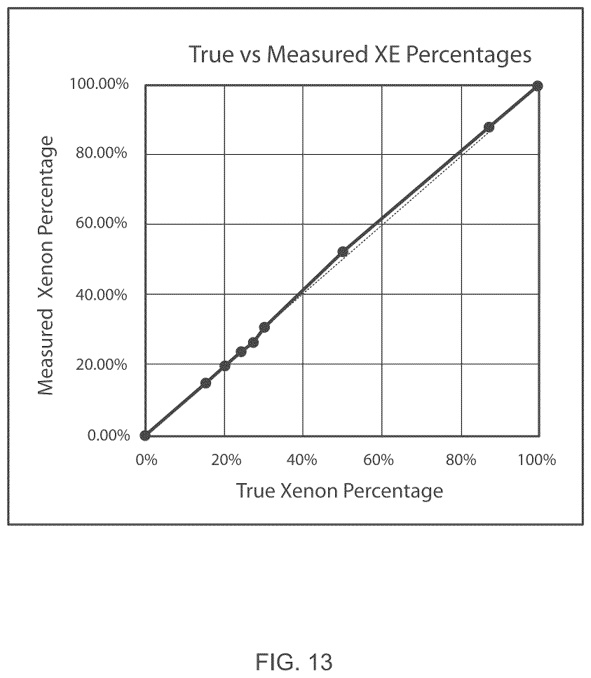

In order to make sure the sensor is accurate for a wide range of concentrations, several mixed compositions of xenon and oxygen are created and measured. Approximately 8 different percentages are tested, with the majority of them being centered around a 20% Xe mixture, due to the fact that 20% Xe is a target concentration for a preferred embodiment target range. For each datapoint, multiple measurements are taken, flushing the sensor between measurements with ambient air, and averaged to obtain concentration values, in order to create the plot shown in FIG. 13.

Furthermore, original data is presented in Table 1, below. Gas mixtures are created in a mixing chamber, by flushing the gas mixture with oxygen and adding xenon or oxygen at a predetermined pressure to obtain mixture with a concentration close to the desirable target concentration. Therefore, the exact gas concentration differs from target due to an error of a pressure gauge. However, for validation purposes, it is important to look at the average and standard deviation value, which characterize the sensor accuracy,

TABLE 1
Validation measurements.

| | True XE percentage | | | | | | | | |
|---|---|---|---|---|---|---|---|---|---|
| | 0% | 15% | 20% | 24% | 27% | 30% | 50% | 87% | 100% |
| Trial 1 | 0.00% | 15.20% | 19.96% | 24.01% | 27.04% | 30.86% | 52.63% | 87.61% | 100.00% |
| Trial 2 | 0.00% | 15.20% | 19.91% | 24.12% | 27.02% | 31.36% | 52.58% | 87.80% | 100.00% |
| Trial 3 | 0.00% | 15.21% | 19.94% | 24.13% | 26.93% | 31.03% | 52.56% | 87.74% | 100.00% |
| Trial 4 | 0.00% | 15.18% | 19.95% | — | 26.95% | 30.91% | 52.50% | 87.69% | 100.00% |
| Trial 5 | 0.00% | 15.19% | 19.93% | — | 26.98% | 31.04% | 52.60% | 87.97% | 100.00% |
| Trial 6 | 0.00% | 15.20% | 19.95% | — | 26.88% | 31.14% | 52.61% | 87.95% | 100.00% |
| Avg | 0.00% | 15.20% | 19.94% | 24.09% | 26.97% | 31.06% | 52.58% | 87.79% | 100.00% |
| Std Dev | 0.00% | 0.01% | 0.02% | 0.05% | 0.05% | 0.16% | 0.04% | 0.13% | 0.00% |

As can be seen from Table 1, average measurements correspond nearly one-to-one with true xenon or other gas percentages. The standard deviations for datapoints are all below 0.2%. Additionally, in a preferred embodiment's intended range of operation (around 20% Xe concentration), standard deviations of measurements drop to less than or equal to 0.05%.

As the data shows, the gas detection system 100 is robust over a complete range of xenon or other gas concentrations (from 0% to 100%),

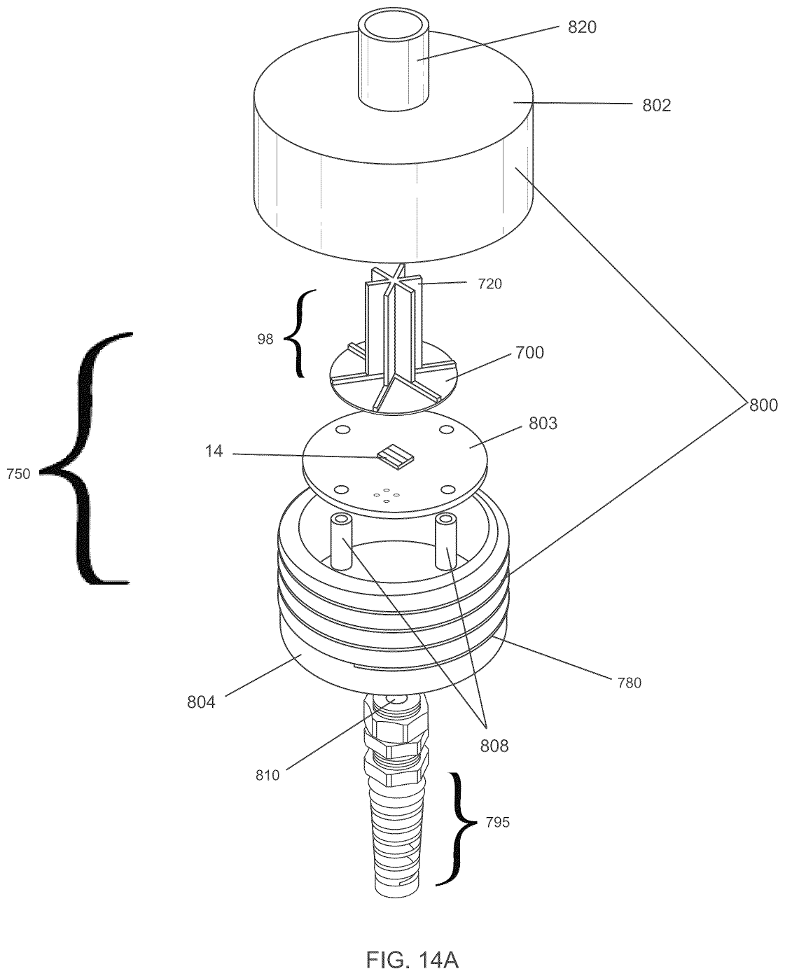

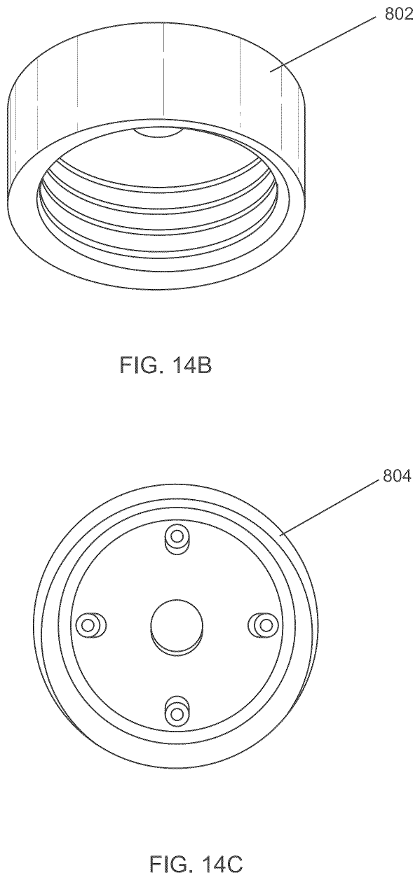

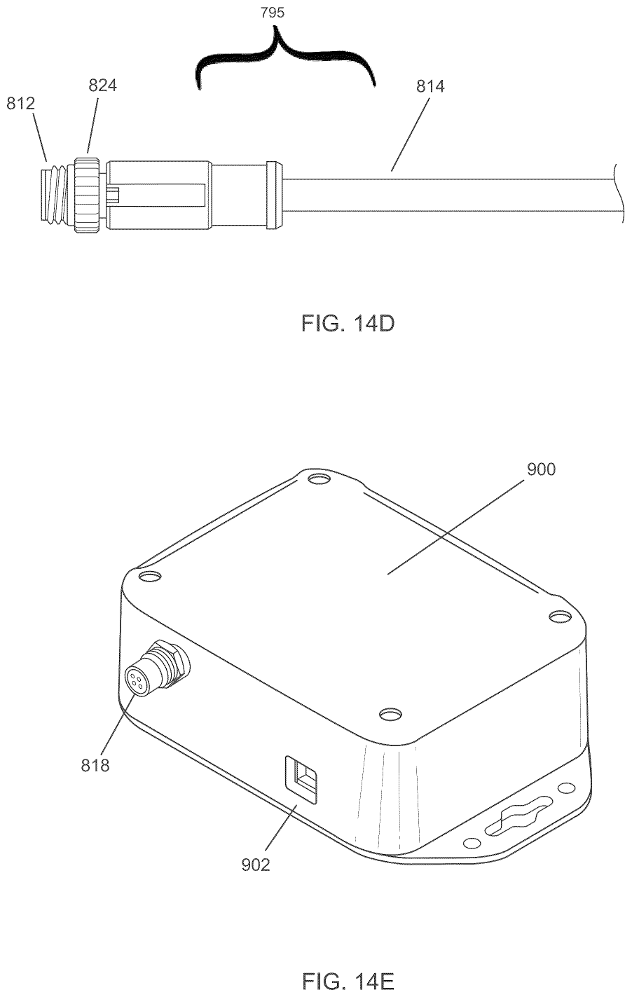

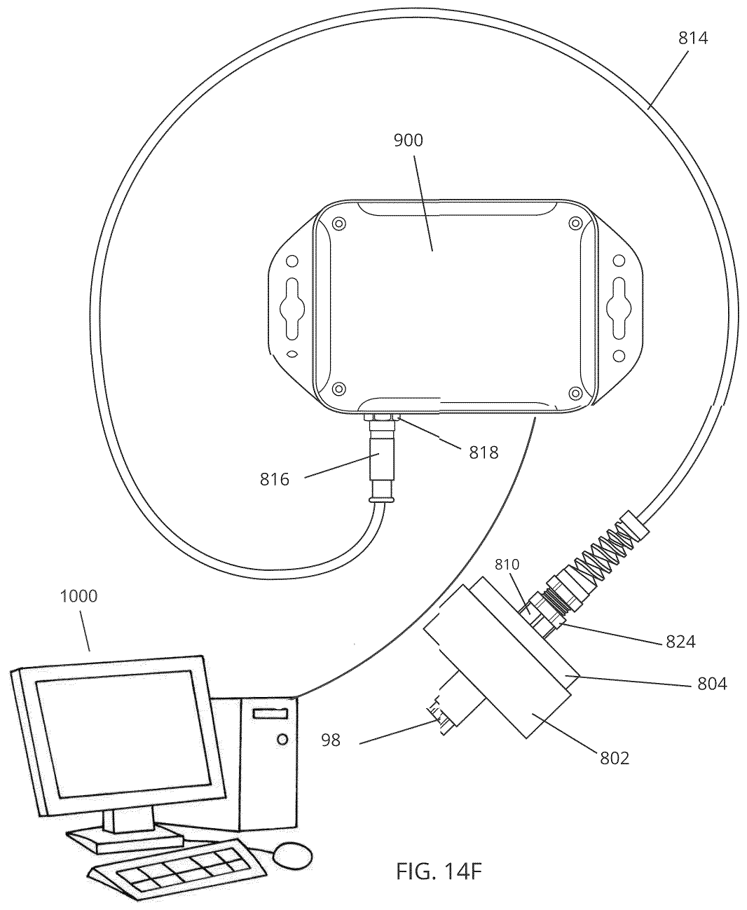

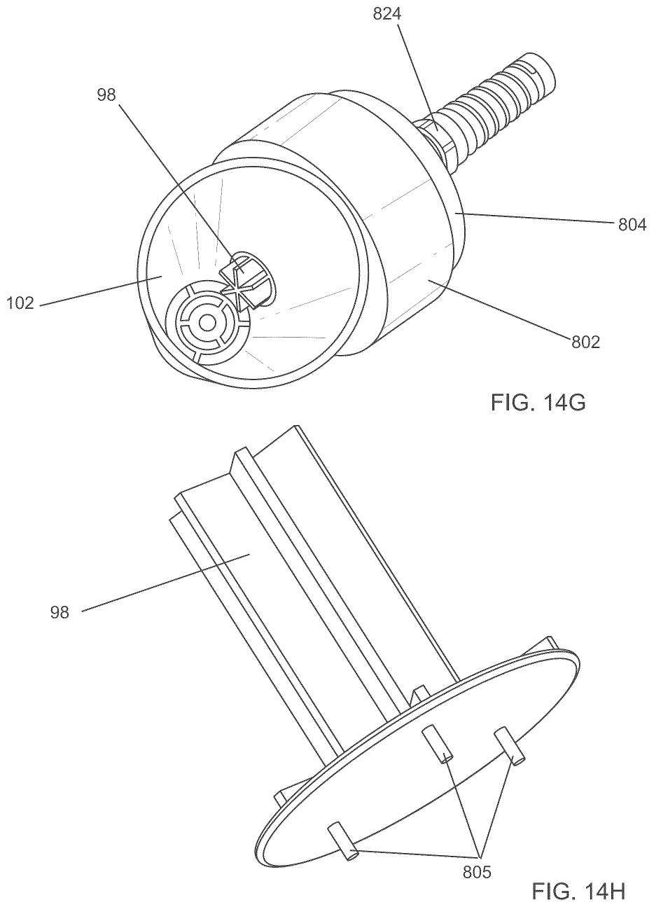

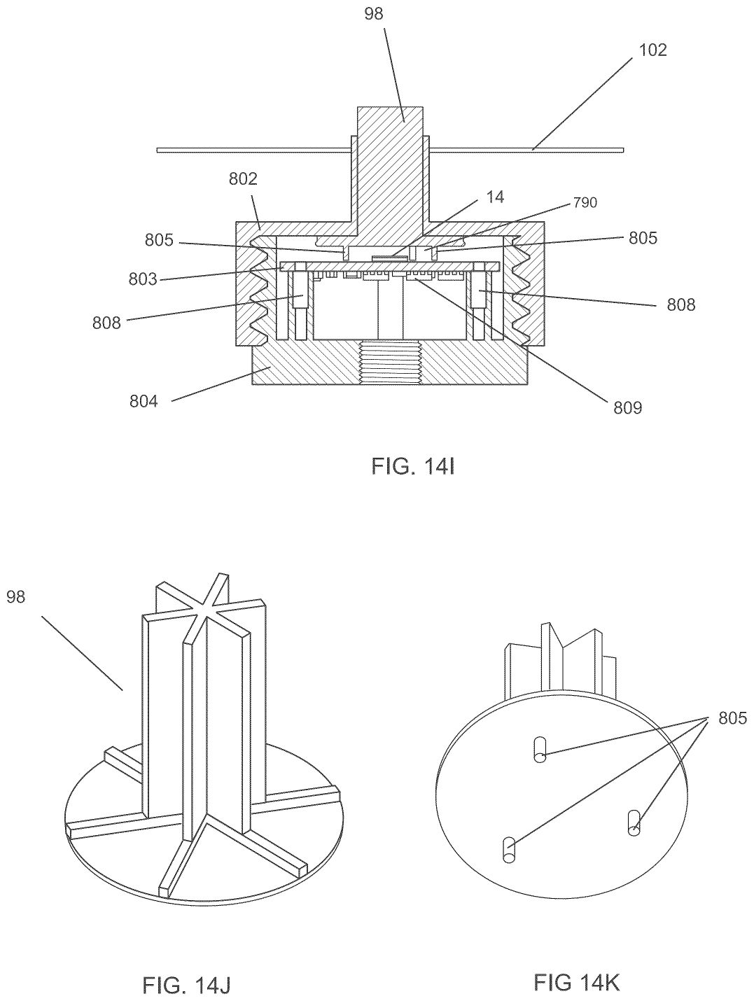

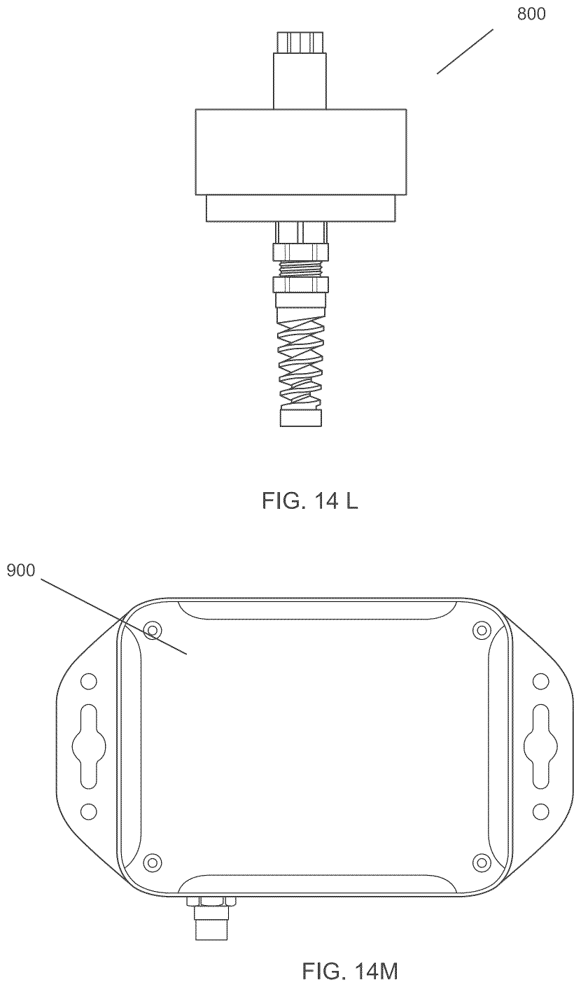

FIGS. 14A-14M illustrate an alternate embodiment of the gas detection system 100, wherein the gas detection system 100 in this embodiment comprises a sensor system 750 and a controller unit 900.

In particular, FIG. 14A illustrates an exploded view of the sensor system 750, wherein a sensor housing 800 comprises a top housing 802 and a bottom housing 804. In this embodiment, the bottom housing 804 includes a set of threads 780 to receive and secure the top housing 802. Furthermore, the top housing 802 preferably is threaded (see FIG. 14B) on an inside surface to correspond with the set of threads 780 on the bottom housing 804 to secure both housings together into a single unit during operation. In this embodiment, the top housing 802 comprises a nozzle 820 that extends outwardly from the top housing 802 to receive a baffle 98.

In this embodiment the baffle 98 comprises a base 700 and a set of fluid diverters 720 extending upwardly from the base 700, wherein each fluid diverter 720 preferably is equidistantly spaced at a particular angle; in other embodiments, the number and spacing of the fluid diverters 720 may vary depending on the usage of the gas detection system 100. As such the baffle 98 preferably press fits up into the sensor nozzle 820 in the top housing 802. A plurality of protrusions 805 (see FIG. 148) extend downwardly from the base 700 to form a gap 790 (see FIG. 141) between the base 700 of the baffle 98 and a signal conditioning and data output unit 803. In this embodiment, the thermal conductivity sensor 14 is located on the signal conditioning and data output unit 803 and below the baffle 98. A plurality of support pegs 808 extend upwardly from the bottom housing 804 to support the signal conditioning and data output unit 803.

Furthermore, a connection port 810 is located and connected below the bottom housing 804. FIG. 14D illustrates a connection unit 795, wherein the connection unit 795 connects the sensor system 750 to the controller unit 900. In this embodiment the connection port 810 connects to a male end 812 of I2C bus 814 via a cord grip 824. A female end 816 (see FIG. 14F) of the I2C bus 814 connects to a controller unit port 818 which is preferably located on an outside of the controller unit 900. In one embodiment, the controller unit 900 preferably further comprises a USB port 902 to program the gas detection system 100 and transmit data to a computing device 1000.

In one embodiment, the baffle 98 extends out from the nozzle 820 of the sensor system 750 wherein the positioning of the baffle 98 allows for a portion of a gaseous mixture to be redirected through the nozzle 820 into the top housing 802. In practice when a breathing line 102 (see FIG. 14G) of an inhalation or anesthetic machine is connected to the sensor system 750 via the nozzle 820, as stated above, a portion of a gas flowing through the line 102 is redirected into sensor system 750 via the baffle 98 in order for the thermal conductivity sensor 14 to measure a conductivity level of the flowing gas.

Furthermore, the utilization of the baffle 98 removes the need for a pumping system to be in the sensor system 750 as the gas flows in through the baffle 98 and into the gap 790 between the base 700 of the baffle 98 and the thermal conductivity sensor 14 to enable measurement of the gas concentration; the flow of gas continues out through the baffle 98 and back into the breathing line 102. In this embodiment, the removal of the baffle 98 creates a longer response time for the thermal conductivity sensor 14 to measure the gas. However, upon implementation of the baffle 98 in the nozzle 820, response times are significantly increased preferably to less than a second.

In this embodiment, the controller unit 900 is free of a display screen and/or any push buttons, but instead connects to an external computing device 1000 (see FIG. 14F) or a central controller of an inhalation equipment. The controller unit 900 further provides data about the measured gas concentration digitally or as analog voltage, so the controller unit 900 has flexibility to be integrated in the automatic systems.

Moreover, in this embodiment, the gas detection system 100 possesses a Xenon measurement range of 0-100%, and a measurement accuracy of plus/minus 18. The type of power supply utilized is a USB port that runs on 5 volts, and the type of power drawn from the USB port is 5 volts, 400 mA, 2 W; the recommended operating temperature is ambient (25° C.). Also, a minimum rating gas temperature is −20° C. and the maximum rating gas temperature is 100° C. Correspondingly, the minimum rating relative humidity is 0% and the maximum rating relative humidity is 100%. Finally, in this embodiment, the gas detection system 100 preferably has a baud rate of 9600, 8-bit data, no parity, and one stop bit.

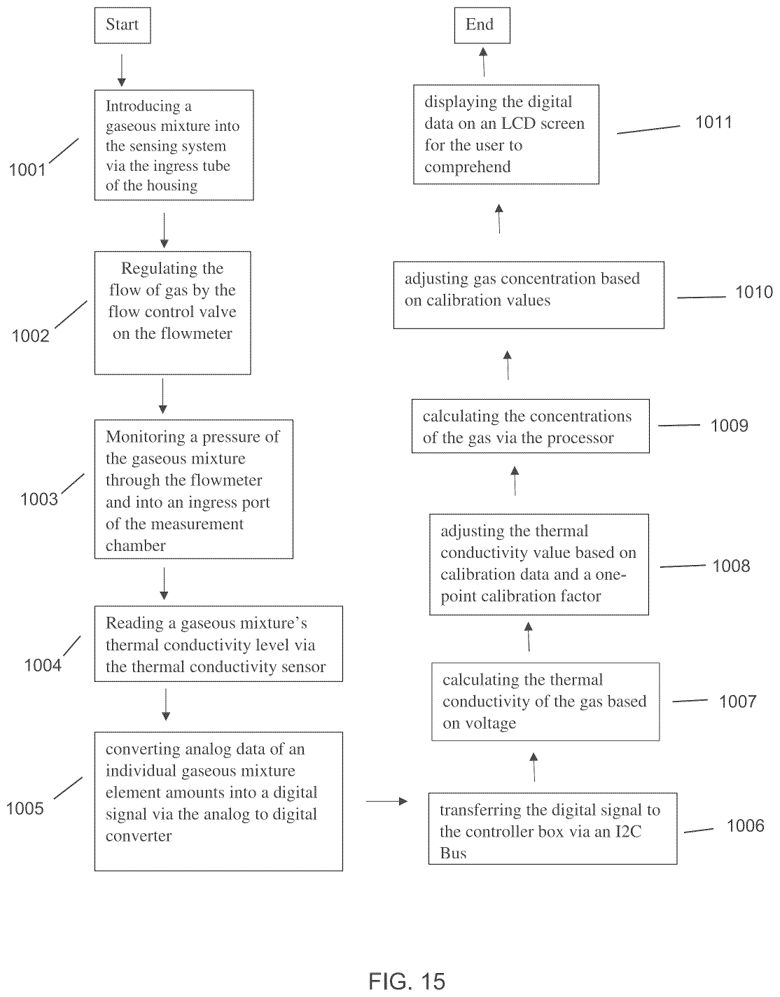

FIG. 15 illustrates a flow diagram for one embodiment of a method of detecting gas concentration utilizing the gas detection system 100. Initially, at step 1001, a gaseous mixture is introduced into the sensing system 20 via the ingress tube 11 of the housing 13. Next, at step 1002, a user of the gas detection system 100 possesses the ability to regulate the flow of gas by the flow control valve 107 on the flowmeter 106. At step 1003, the user may monitor a pressure of the gaseous mixture through the flowmeter 106 and into the ingress port 26 of the measurement chamber 24. At step 1004, the thermal conductivity sensor 14 may read a gaseous mixture's thermal conductivity level and generate an analog voltage. Then, in step 1005, the system may convert analog data of the individual gaseous mixture element amounts into a digital signal via the analog to digital converter 52 before transferring the digital data to the controller box 22 via the I2C Bus 56, in step 1006. At step 1007, the processor 86 may calculate the thermal conductivity of the gas based on voltage. Further in step, 1008, the processor 86 may adjust the thermal conductivity value based on calibration data and a one-point calibration factor. Next, at step 1009 the processor 86 may calculate the concentrations of the gas before adjusting gas concentration based on calibration values, at step 1010. Lastly, in step 1011, the system may display the digital data on the LCD screen 88 for the user to comprehend.

It should be understood that various alternatives to the embodiments of the disclosure described herein may be employed in practicing the disclosure. Elements of an implementation of the apparatus described herein may be independently implemented or combined with other implementations.

What is claimed is:

1. A gas detection system comprising:
a sensing system, wherein the sensing system further comprises:
a signal conditioning and data output unit;
a thermal conductivity sensor located on the signal conditional and data output unit;
a measurement chamber, wherein the measurement chamber encloses the thermal conductivity sensor and further comprises:
an input port; and
an output port;
a flowmeter, wherein the flowmeter is located on an outside of the sensing system;
an ingress tube and an egress tube, wherein the tubes are configured to connect to an external gas source to flow a gaseous mixture through the measurement chamber;
a controller, wherein the controller further comprises:
a display screen;
a set of push buttons; and a
processor;
wherein the sensing system and the controller are in digital communication.

2. The gas detection system of claim 1, wherein the thermal conductivity sensor measures a thermal conductivity level of the gaseous mixture.

3. The gas detection system of claim 1, wherein the sensing system further comprises a pumping system.

4. The gas detection system of claim 1, wherein the sensing system and the controller are connected via a I2C bus.

5. The gas detection system of claim 1, wherein a programmable memory is located on the signal conditioning and data output unit.

6. The gas detection system of claim 5, wherein a set of calibration values is stored in the programmable memory.

7. The gas detection system of claim 1 further comprising:
a plurality of surface mount heating resistors that surround the thermal conductivity sensor to regulate a temperature in the measurement chamber.

8. The gas detection system of claim 1 further comprising:
an analog to digital converter to covert an analog measurement of the thermal conductivity sensor into a digital signal that is transferred to the controller.

9. The gas detection system of claim 1, wherein the processor calculates a gas percentage of the gaseous mixture based on the thermal conductivity level measured by the thermal conductivity sensor.

10. The gas detection system of claim 7, wherein the temperature of the measurement chamber is between forty-five and fifty-five degrees Celsius.

11. A gas detection system comprising:
a sensor system, wherein the sensor system further comprises:
a sensor housing comprising a top housing and a bottom housing;
a nozzle, wherein the nozzle extends outwardly from the top housing;
a baffle, wherein the baffle further comprises:
a base;
a set of fluid diverters extending upwardly from the base into the nozzle;
a signal conditioning and data output unit;
a thermal conductivity sensor located on the signal conditioning and data output unit;
wherein a gap is formed between the base of the baffle and the top housing, and the base of the baffle and the signal conditioning and data output unit;
a controller unit; and
a computing device, wherein the controller unit and the computing device are in digital communication.

12. The gas detection system of claim 11 further comprising a connection port located and connected below the bottom housing.

13. The gas detection system of claim 11 further comprising a connection unit to connect the sensor system to the controller unit.

14. The gas detection system of claim 11 wherein a portion of a gaseous mixture is redirected into through the nozzle into the top housing by the fluid diverters of the baffle.

15. A method of detecting a concentration of a gas utilizing the gas concentration system of claim 1 comprising the steps of:
introducing a gaseous mixture into the sensing system;
measuring a thermal conductivity level of the gaseous mixture by the thermal conductivity sensor;
comparing the thermal conductivity level of the gaseous mixture to a set of calibration values; and
calculating an individual gas concentration by matching the thermal conductivity level of the gaseous mixture to the set of calibration values;
displaying the gas concentration level on the display screen of the controller.

16. A method of detecting a concentration of a gas utilizing the gas concentration system of claim 11 comprising the steps of:
introducing a gaseous mixture into the sensing system;
measuring a thermal conductivity level of the gaseous mixture by the thermal conductivity sensor;
comparing the thermal conductivity level of the gaseous mixture to a set of calibration values; and
calculating an individual gas concentration by matching the thermal conductivity level of the gaseous mixture to the set of calibration values;
displaying the gas concentration level on the display screen of the controller.
